(19) United States
(12) Patent Application Publication
(10) Pub. No.: US 2016/0295472 A1
(43) Pub. Date: Oct. 6, 2016

(54) OPTIMIZING CRE CONFIGURATION

(71) Applicant: TELEFONAKTIEBOLAGET LM ERICSSON (PUBL), Stockholm (SE)

(72) Inventors: Min HUANG, Beijing (CN); Lei XIAO, Beijing (CN); Yang TIAN, Beijing (CN)

(73) Assignee: Telefonaktiebolaget LM Ericsson (publ), Stockholm (SE)

(21) Appl. No.: 15/030,978

(22) PCT Filed: Nov. 6, 2013
(86) PCT No.: PCT/CN2013/086622

§ 371 Date: Apr. 21, 2016

(51) Int. Cl. H04W 36/00; H04W 36/20; H04W 74/08; H04W 72/04; H04L 5/00

(52) U.S. Cl. CPC H04W 36/0083; H04W 72/0413; H04W 72/042; H04L 5/006; H04W 74/0833; H04W 36/20

(57) ABSTRACT

A small cell has a service area that is within or adjacent to service area(s) of one or more neighboring cells. A base station of the small cell monitors uplink (UL) or downlink (DL) interference to the small cell due to the neighboring cells; and based on the monitored interference, adapts cell range expansion (CRE) configuration of the small cell associated with at least one of the neighboring cells.

### TECHNICAL FIELD

The present disclosure relates to radio communication, and in particular, to cell range expansion (CRE) configuration in wireless networks.

### BACKGROUND

A cellular network typically includes some areas with poor coverage (e.g. a coverage hole). In those areas, it may be desirable to deploy additional capacity to ensure user satisfaction. The added capacity may be in the form of additional macro base stations and/or in the form of lower output power base stations with a smaller area coverage. Examples of the lower output power base stations include micro base stations, pico base stations, home base stations, relays, etc. Throughout the present disclosure, a cell served by a lower output power base station will be referred to as a small cell, as it has a smaller coverage compared with a cell served by a macro base station.

A network deployment that uses both macro base stations and lower output power base stations is referred to here as a heterogeneous network or “HetNet”. A diagrammatic view of a heterogeneous network is shown in FIG. 1, in which a Macro base station 101 provides a larger cell area coverage or a macro cell 102. Within the macro cell 102 is there deployed a lower output power base station 103, which provides a smaller cell area coverage or a small cell 104. Please be noted that more than one lower output power base station can be deployed within the coverage of a macro base station, which will serve more than one small cells.

As described above, in a heterogeneous network as shown in FIG. 1, a number of small cells (e.g. pico cells and femto cells) can be deployed within coverage of a macro cell. A border of a small cell is usually determined based on equality of downlink (DL) signal power. In other words, the border of the small cell should be set where DL signal power from the base station of the macro cell is equal to DL signal power from the base station of the small cell. If the same carrier frequency is applied in the heterogeneous network for sake of spectrum efficiency, inter-cell interferences between the macro cell and small cells can be severe. Taking a UE served by the macro cell 102 and located near the edge of a small cell 104 (e.g. UE 1 in FIG. 1) for example, UE 1 has a much longer distance from the macro base station 101 than from the base station 103 of small cell. So uplink (UL) signals which are transmitted from UE 1 to the macro base station 101 and which just satisfy the receiving sensitivity at the macro base station 101 will turn out to be a strong interference at the base station 103 of small cell.

In order to reduce such strong UL interference at the base station of a small cell, a technique called cell area expansion (CRE) can be adopted. Specifically, a positive bias is added into the handover triggering condition when DL signal quality of the small cell is evaluated. This is equivalent to expanding the cell range or coverage of the small cell when a UE takes handover between the macro cell and the small cell. As illustratively shown in FIG. 1, the cell coverage 105 in dashed lines is a cell area of the base station 103 after CRE is employed and the area between the original cell coverage 105 and the expanded cell coverage 105 is referred to as an expanded cell area in the context of this disclosure. By way of CRE, for a UE served by the macro cell and close to the edge of the small cell 105 (e.g. UE 2), its distance to the base station 103 of the small cell is increased and so the UL interference to the small cell can be greatly reduced.

However, when CRE is configured between the small cell and the macro cell, a UE (e.g. UE 3) located at the expanded cell area of the small cell could suffer strong DL interference from the macro cell, because it is near the macro base station. In order to make UE 3 survive such strong DL interference, a new subframe called almost blank subframe (ABS) can be utilized, in which power on some physical channels and/or some activity are reduced. Taking a Long Term Evolution (LTE) system for example, the macro cell can mute PDSCH (Physical Downlink Shared Channel) in ABS, and only maintain CRS (cell reference signal)/PSS (primary synchronization signal)/SSS (secondary synchronization signal)/BCCH (broadcast control channel)/PCCH (paging control channel). Correspondingly, the small cell can utilize subframes where ABS is configured in the macro cell to schedule its UEs at its cell edge.

Though the application of CRE and ABS can effectively reduce the downlink and uplink interference from the macro cell to the small cell, it also has some disadvantages. For example, the spectrum efficiency in the macro cell could be reduced, because DL data transfer is only allowed in non-ABS subframes. Also, UEs in the expanded cell area of the small cell are not served by the cell with the largest downlink signal strength.

### SUMMARY

It is therefore an object to address some of the problems outlines above, and to provide a solution for optimizing CRE configuration between a small cell and its neighboring cells.

According to a first aspect of the present disclosure, a method performed by a base station of a small cell is disclosed. The small cell has a service area that is within or adjacent to service area(s) of one or more neighboring cells. The method includes monitoring uplink (UL) or downlink (DL) interference to the small cell due to the neighboring cells; and based on the monitored interference, adapting cell range expansion (CRE) configuration of the small cell associated with at least one of the neighboring cells.

In an example, the UL interference to the small cell may be monitored based on at least one of signal-to-interference-plus-noise ratio (SINR) values and interference-over-thermal (IoT) values of one or more UL signals received by the base station of the small cell.

In an example, the UL interference to the small cell may be monitored and the adapting CRE configuration of the small cell may comprise: determining whether the monitored UL interference is higher than a first threshold or not; in response to determining that the monitored UL interference is higher than a first threshold, selecting a neighboring cell from the one or more neighboring cells; and increasing the CRE configuration of the small cell associated with the selected neighboring cell. In this example, the neighboring cell may be selected from a neighboring cell list maintained by the base station of the small cell, be selected based on an automatic neighbor relation (ANR) function, or be selected by recognizing a cell identification from a demodulation reference signal or random access preamble received by the base station of the small cell.

In an example, increasing the CRE configuration of the small cell associated with the selected neighboring cell may comprise, if CRE is not enabled between the small cell and the selected neighboring cell, enabling CRE between the small cell and the selected neighboring cell; or if CRE is already enabled between the small cell and the selected neighboring cell, enlarging a size of an expanded cell area for the CRE between the small cell and the selected neighboring cell.

In an example, before increasing, the method may further comprise, sending a message from the base station of the small cell to a base station of the selected neighboring cell, including a cell type of the small cell and a request for increasing CRE configuration; and receiving from the base station of the selected neighboring cell a confirmation or a rejection of increasing CRE configuration; wherein CRE configuration between the small cell and the selected neighboring cell is increased, only if a confirmation of increasing CRE configuration is received by the base station of the small cell.

In an example, the cell type may be a cell size and in case no CRE exists between the small cell and the selected neighboring cell, a confirmation of enabling CRE can be received by the base station of the small cell only if a size of the small cell is not larger than a size of the selected neighboring cell.

In an example, the method may further comprise repeating said selecting and increasing until the monitored UL interference is lower than the first threshold or all the neighboring cells are selected.

In another example, the DL interference to the small cell may be monitored and the adapting CRE configuration of the small cell may comprise: determining whether the monitored DL interference is lower than a second threshold or not; in response to determining that the monitored DL interference is lower than the second threshold, selecting one or more neighboring cells from the neighboring cells, between which and the small cell CRE is established; and decreasing the CRE configuration of the small cell associated with at least one of the selected neighboring cells. For example, all neighboring cells between which and the small cell CRE is established can be selected, if RSRQ of the small cell in a non-ABS subframe is greater than a fifth threshold; or a neighboring cell between which and the small cell CRE is established can be selected if the RSRP of this neighboring cell in any subframe is less than a sixth threshold.

In another example, decreasing the CRE configuration of the small cell associated with at least one of the selected neighboring cells may comprise: disabling CRE between the small cell and the at least one of the selected neighboring cells; or reducing a size of an expanded cell area for the CRE between the small cell and the at least one of the selected neighboring cells, without disabling CRE.

In another example, monitoring DL interference to the small cell may comprise identifying one or more user equipments (UEs) in an expanded cell area of the small cell which is generated by CRE; and determining DL interference to the small cell based on signal quality measurements reported by the identified UEs.

In another example, said identifying one or more user equipments (UEs) in an expanded cell area may comprise: configuring one or more UEs served by the small cell to measure and report reference signal received powers (RSRP) of the small cell and the neighboring cells; and identifying an UE as being in the expanded cell area, if RSRP of the small cell reported by the UE is smaller than a third threshold, or if RSRP of the small cell reported by the UE is smaller than RSRP of one of the neighboring cells by a fourth threshold.

In another example, the signal quality measurements reported by the identified UEs may include reference signal received qualities (RSRQ) of the small cell in a non-almost-blank-subframe (non-ABS subframe) and reference signal received powers (RSRP) of the neighboring cells in any subframe.

In another example, the method may further comprise: upon decreasing the CRE configuration of the small cell associated with the at least one of the selected neighboring cells, setting a timer, during a period of which increasing CRE configuration associated with the at least one of the selected neighboring cells is prevented.

In another example, before said decreasing, the method may further comprise sending a message from the base station of the small cell to a base station of the at least one of the selected neighboring cells, including a request for decreasing CRE configuration; and receiving from the base station of the at least one of the selected neighboring cells a confirmation or a rejection of decreasing CRE configuration; wherein CRE configuration between the small cell and the at least one of the selected neighboring cells is decreased, only if a confirmation of decreasing CRE configuration is received by the base station of the small cell.

According to a second aspect of the present disclosure, a base station of a small cell is disclosed. The small cell has a service area that is within or adjacent to service area(s) of one or more neighboring cells. The base station comprises a monitoring unit and an adapting unit. The monitoring unit is configured to monitor uplink (UL) or downlink (DL) interference to the small cell due to the neighboring cells; and the adapting unit is configured to adapt cell range expansion (CRE) configuration of the small cell associated with at least one of the neighboring cells based on the monitored interference.

According to a third aspect of the present disclosure, a base station of a small cell is disclosed. The base station comprises a processor and a memory. The memory contains instructions executable by the processor, whereby the base station is operative to carry out operations as described above according to the first aspect of the present disclosure.

According to a fourth aspect of the present disclosure, a non-transitory computer-readable medium containing instructions stored thereon is disclosed. When executed by a base station of a small cell which has a service area that is within or adjacent to service area(s) of one or more neighboring cells, the instructions cause the base station to perform operations. The instructions comprise program code to carry out operations as described above according to the first aspect of the present disclosure.

By adapting CRE configuration between the small cell and its neighboring cells based on UL/DL interference to the small cell, the work load for an operator's manual deployment and maintenance of the small cell and its CRE configuration can be significantly reduced, because the operator does not need to take extensive radio signal measurement and network dimensioning in order to determine the CRE configuration for a small cell. In addition, adapting CRE configuration based on UL/DL interference to the small cell can automatically optimize the CRE configuration of the small cell by taking all the factors that could affect CRE configuration into account in the resulting interference.

### BRIEF DESCRIPTION OF THE DRAWINGS

The above and other aspects, features, and benefits of various embodiments herein will become more fully apparent, by way of example, from the following detailed description and the accompanying drawings, in which:

FIG. 1 illustrates a heterogeneous network where the present disclosure may be applied;

FIG. 2 is a flow diagram of a method for optimizing CRE configuration according to an embodiment;

FIG. 3 is a flow diagram of a method for increasing CRE configuration according to an embodiment;

FIG. 4 is a flow diagram of a method for increasing CRE configuration according to another embodiment;

FIG. 5 is a flow diagram of a method for increasing CRE configuration according to yet another embodiment;

FIG. 6 is a flow diagram of a method for decreasing CRE configuration according to an embodiment;

FIG. 7 is a flow diagram of a method for monitoring DL interference to a small cell according to an embodiment;

FIG. 8 is a flow diagram of a method for decreasing CRE configuration according to another embodiment;

FIG. 9 is a flow diagram of a method for decreasing CRE configuration according to yet another embodiment;

FIG. 10 is a diagrammatic view of a base station of a small cell according to an embodiment;

FIG. 11 is a diagrammatic view of a DL monitoring unit according to an embodiment;

FIG. 12 is a diagrammatic view of a base station of a small cell according to another embodiment; and

FIG. 13 is a diagrammatic view of a base station of a small cell according to yet another embodiment.

### DETAILED DESCRIPTION

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not to obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

Although the description is given for user equipment (UE), it should be understood by the skilled in the art that “UE” is a non-limiting term comprising any wireless device or node equipped with a radio interface allowing for at least one of: transmitting signals in the UL and receiving and/or measuring signals in the DL. Some examples of UE in its general sense are a PDA, laptop, mobile, and sensor. A UE may be and preferably is capable of operating or at least performing measurements in one or more frequencies, carrier frequencies, component carriers or frequency bands. A UE may operate in a single-RAT, a multi-RAT, or a multi-standard mode, e.g., an example dual-mode UE may operate with any one or a combination of WiFi and LTE.

A cell is associated with a base station, and a cell is further associated with a carrier frequency and a radio access technology. A base station comprises in a general sense any node transmitting radio signals in the downlink (DL) and/or receiving radio signals in the uplink (UL). Some example base stations are eNodeB, eNB, Node B, macro/micro/pico radio base station, home eNodeB, relay, repeater, sensor, transmitting-only radio nodes or receiving-only radio nodes. A base station may operate and/or perform measurements in one or more frequencies, carrier frequencies or frequency bands and may be capable of carrier aggregation. A base station may also use a single-radio access technology (RAT), a multi-RAT, or operate using a multi-standard node, e.g., using the same or different base band modules for different RATs.

A subframe may be any time interval, time period, or time slot, which may be pre-defined. An example is an LTE subframe.

The example embodiments are not limited to LTE, but may apply to any Radio Access Network (RAN), single-RAT or multi-RAT. Some other RAT examples are LTE-Advanced, UMTS, GSM, and cdma2000.

Embodiments described herein may be considered as independent embodiments or may be considered in any combination with each other to describe non-limiting examples. In the non-limiting examples below, an eNB is used as an example base station, a macro base station is used as the example of, and the term includes, any type of higher power base station serving a larger cell, referred to as a macro cell, and a base station of a small cell (or a small cell BS) is used as the example of, and the term includes, any type of lower power base station serving a smaller cell, referred to as a small cell.

Reference throughout the specification to “one embodiment” or “an embodiment” means that a particular feature, structure, or characteristic described in connection with an embodiment is included in at least one embodiment of the present disclosure. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

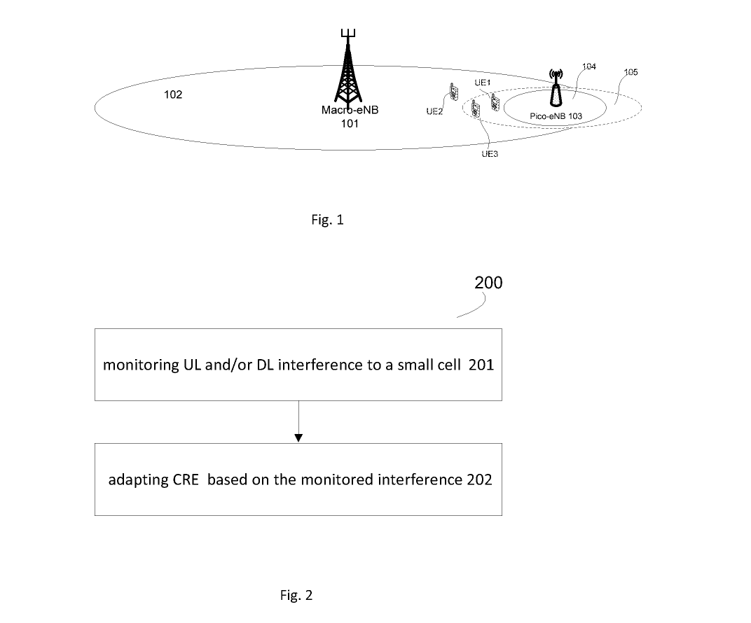

Referring now to FIG. 2, FIG. 2 illustrates a flow diagram of a method 200 for optimizing CRE configuration according to an embodiment of the present disclosure. The method 200 is performed in this embodiment by a base station of a small cell (e.g. the base station 103 in FIG. 1). As described in connection with FIG. 1, the base station of the small cell has a service area 104 that is within or adjacent service area(s) of one or more neighboring cells. For example, in the scenario shown in FIG. 1, the macro cell served by the macro base station 101 is a neighboring cell of the small cell. However, it should be appreciated that, although now shown in FIG. 1, the service area of the small cell can also be within a service area(s) of one or more other macro neighboring cells and that there can also be one or more other small cells whose service areas are adjacent to (including partially overlapping and non-overlapping) that of the small cell. The method 200 starts at block 201, where the base station of the small cell (e.g. 103) monitors UL or DL interference to the small cell due to its neighboring cells (e.g. 101).

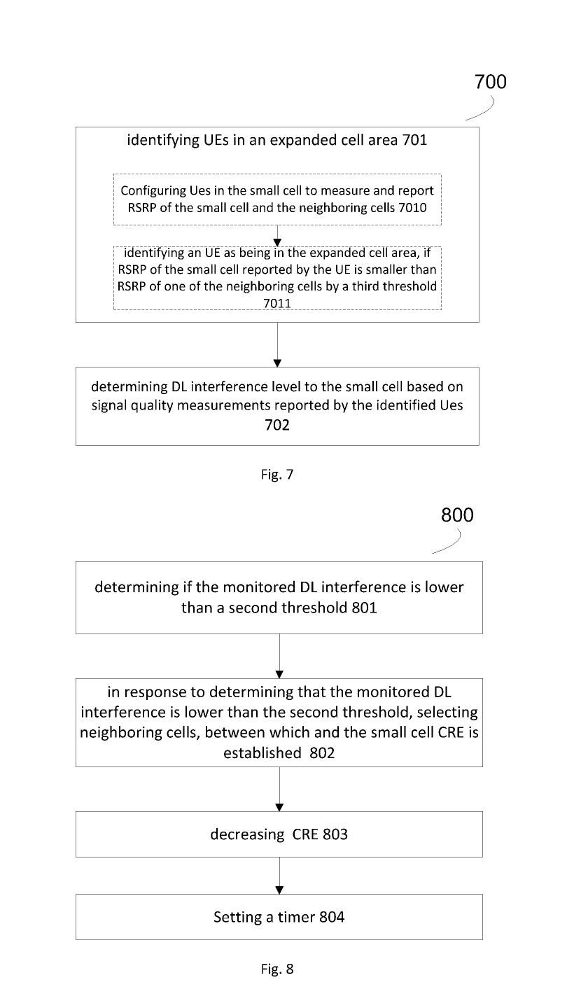

In an example, the UL interference to the small cell can be monitored based on at least one of signal-to-interference-plus-noise ratio (SINR) values and interference-over-thermal (IoT) values of one or more UL signals received by the base station of the small cell. If the base station of the small cell receives more than one UL signals, the UL interference to the small cell may be determined for example by an average value, a weighted average value or a statistic value of the SINR values or IoT values of these UL signals. DL interference to the small cell refers to DL interference to an UE served by the small cell and is usually measured and reported to the base station of the small cell by the UE. An example of monitoring of DL interference to the small cell will be described in detail with reference to FIG. 7.

Then the method 200 proceeds to block 202, where the base station of the small cell adapts CRE configuration of the small cell associated with at least one of its neighboring cells. By adapting CRE configuration between the small cell and its neighboring cells based on UL/DL interference to the small cell, the work load for an operator's manual deployment and maintenance of the small cell and its CRE configuration can be relieved, because the operator does not need to take extensive radio signal measurement and network dimensioning to know the overlapping situation about the small cell and its neighboring cells (e.g. a macro cell) so as to determine the CRE configuration (e.g. whether CRE should be enabled or how large should the expanded cell area be) for a small cell. In addition, knowing the cell overlapping situation may not be enough to determine the CRE configuration. Some other factors such as UE geographical distribution or data traffic type may also affect the need for CRE configuration as well as the size of expanded cell area generated by CRE. By adapting CRE configuration based on UL/DL interference to the small cell, the CRE configuration can be automatically optimized since all the factors that could affect CRE configuration are taken into account in the resulting interference to the small cell. This can improve the efficiency of the heterogeneous network because CRE will be configured in an appropriate manner, neither insufficient nor redundant.

Examples of adapting CRE configuration of the small cell may include increasing CRE configuration and decreasing CRE configuration and will be described respectively in respect to whether the DL interference or UL interference is monitored below.

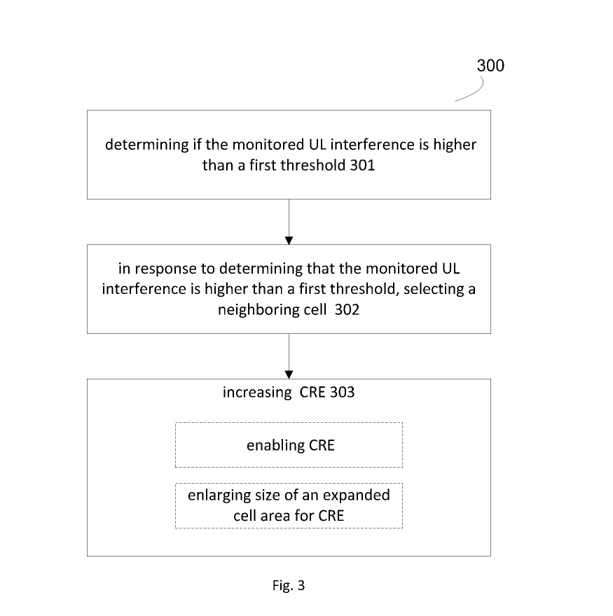

With reference to FIG. 3 now, FIG. 3 illustrates a flow diagram of an example method 300 for increasing CRE configuration in case the UL interference to the small cell is monitored. At block 301, it can be determined by the base station of the small cell whether the monitored UL interference is higher than a first threshold or not. In an example, the first threshold can be predetermined by the operator. At block 302, in response to determining that the monitored UL interference is higher than the first threshold, a neighboring cell may be selected from the one or more neighboring cells of the small cell. At block 303, the base station of the small cell can increase CRE configuration of the small cell associated with the selected neighboring cell. By increasing CRE configuration in case of high UL interference, the UL interference to the small cell can be reduced and the load of the small cell can also be increased.

According to an example of the present disclosure, increasing the CRE configuration of the small cell associated with the selected neighboring cell may comprise, if CRE is not enabled between the small cell and the selected neighboring cell, enabling CRE between the small cell and the selected neighboring cell; or if CRE is already enabled between the small cell and the selected neighboring cell, enlarging a size of an expanded cell area for the CRE between the small cell and the selected neighboring cell, as shown by dashed-line blocks in 303.

In an example, a neighboring cell may be selected from a neighboring cell list maintained by the base station of the small cell. In another example, a neighboring cell may be selected based on an automatic neighbor relation (ANR) function. In other words, the base station of the small cell may discover a new neighboring cell by way of ANR function and then select this new neighboring cell. In yet another example, a neighboring cell may be selected by recognizing a cell identification from a demodulation reference signal or random access preamble received by the base station of the small cell.

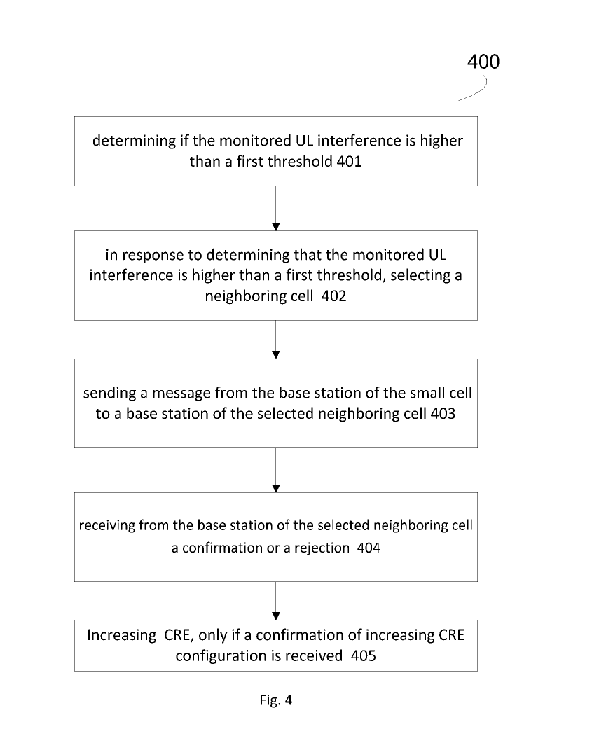

With reference to FIG. 4, FIG. 4 illustrates a flow diagram of a method for increasing CRE configuration according to another embodiment of the present disclosure. As shown, blocks 401 and 402 are the same as blocks 301 and 302 and will not be described in detail herein. After selecting a neighboring cell from the one or more neighboring cells of the small cell at block 402, the base station of the small cell may send a message to a base station of the selected neighboring cell at block 403. The message may include a cell type of the small cell and a request for increasing CRE configuration. After receiving this request, the base station of the selected neighboring cell may reply to indicate whether to grant this request or not. At block 404, the base station of the small cell may receive from the base station of the selected neighboring cell a confirmation or a rejection of increasing CRE configuration. And at block 405, the base station of the small cell may increase CRE configuration between the small cell and the selected neighboring cell, only if a confirmation of increasing CRE configuration is received by the base station of the small cell.

In an example, the cell type included in the message may indicate a size of the small cell. In case no CRE exists between the small cell and the selected neighboring cell, after receiving the request for increasing CRE configuration, the base station of the selected neighboring cell can determine whether to agree establishing CRE between itself and the small cell from which the message originates based on the size of the small cell and its own cell size. According to an example, the base station of the selected neighboring cell may only grant establishing of CRE if the size of the small cell is not larger than its own cell size. In other words, according to this example, the base station of the small cell can only receive a confirmation of enabling CRE if a size of the small cell is not larger than a size of the selected neighboring cell.

The message here may be a modified standardized message or may be a specifically designed message. In an example, the “Load information” message standardized in 3GPP (e.g. 3GPP TS36.423) can be modified to incorporate a field to indicate the cell size, such as very small, small, medium, large and etc. In another example, the “Mobility change request” message also standardized in 3GPP (e.g. 3GPP TS36.423) can be modified to incorporate a field for cell size and in addition, its field “cause” can be modified to include parameters related to decreasing or increasing CRE configuration. However, it will be appreciated that these are just examples of messages and the present invention is not limited in this regard.

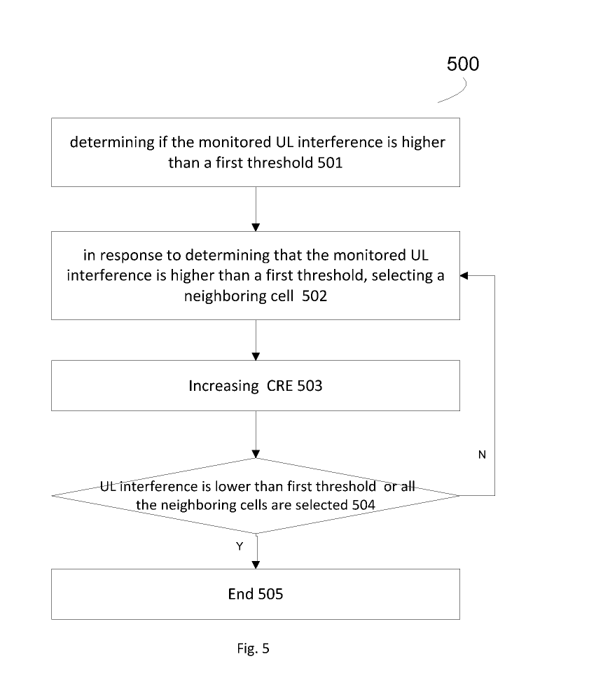

With reference to FIG. 5 now, FIG. 5 illustrates a flow diagram of a method for increasing CRE configuration according to yet another embodiment. As shown, FIG. 5 is almost identical to FIG. 3, except that FIG. 5 further includes block 504. After the base station of the small cell increases CRE configuration associated with the selected neighboring cell at block 503, the base station of the small cell may further determine at block 504 whether the UL interference to the small cell is lower than the first threshold or all the neighboring cells are selected. There may be multiple neighboring cells for the small cell. If it is determined after increasing CRE of the small cell associated with a selected neighboring cell that the UL interference level to the small cell is still higher than the first threshold, then in order to further reduce the UL interference, the base station of the small cell can select another neighboring cell (if there is any more) and increase CRE between this neighboring cell and the small cell. Please be noted that CRE can be established between the small cell and different neighboring cells. For example, as shown in FIG. 1, CRE may be established or enabled between the small cell of base station 103 and the macro cell of base station 101, and CRE may also be established between the small cell of base station 103 and a macro cell of another neighboring base station not shown in FIG. 1. The process of selecting and increasing CRE as shown at blocks 502 and 503 can be repeated until it is determined that the UL interference to the small cell is lower than the first threshold or until all the neighboring cells have been explored.

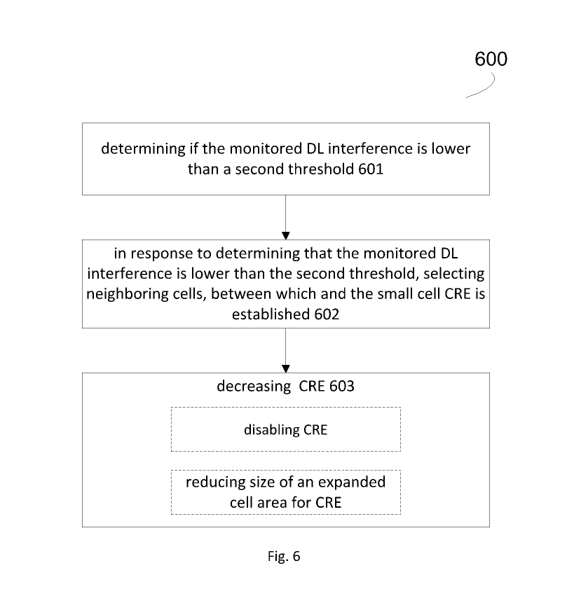

In the following, examples of adapting CRE configuration in case DL interference is monitored will be described with reference to FIG. 6 through FIG. 9.

FIG. 6 illustrates a flow diagram of a method for decreasing CRE configuration according to an embodiment of the present disclosure. At block 601, it can be determined by the base station of the small cell whether the monitored DL interference is lower than a second threshold. In an example, the second threshold can be predetermined by the operator.

An example method of monitoring DL interference to the small cell is illustrated in FIG. 7, which is based on the signal quality measurement reported by UEs located in an expanded cell area generated by CRE. At block 701, the base station of the small cell may identify one or more user equipments (UEs) in the expanded cell area of the small cell which is generated by CRE. At block 702, the base station of the small cell may determine DL interference to the small cell based on signal quality measurements reported by the identified UEs. Examples of the signal quality measurements reported by the identified UEs may include but not limited to reference signal received qualities (RSRQ) of the small cell in a non-almost-blank-subframe (non-ABS subframe) or reference signal received powers (RSRP) of the neighboring cells in any subframe. In case more than one UE is identified to be located in the expanded cell area, the base station of the small cell would receive multiple signal quality measurements from these identified UEs and it can calculate an average value, a weighted average value or some kind of statistic value of the reported signal quality measurements as a basis for the DL interference to the small cell. It would be appreciated by those skilled in the art that different parameters other than RSRP and RSRQ can also be used to determine the DL interference to a cell.

According to an example of the present disclosure, in order to identify one or more UEs located in the expanded cell area generated by CRE, the base station of the small cell may configure one or more UEs served by the small cell to measure and report reference signal received powers (RSRP) of the small cell and the neighboring cells, as shown at block 7010. And if RSRP of the small cell reported by a UE is smaller than a third threshold, or if RSRP of the small cell reported by a UE is smaller than RSRP of one of the neighboring cells by a fourth threshold, then the base station of the small cell can identify the UE as being in the expanded cell area, as shown at block 7011. The third and fourth thresholds can be predetermined by the operator. In an example, the third threshold can be a RSRP value at which a UE in the small cell would make handover to a neighboring cell in case of no CRE configuration. If CRE is enabled, then a UE located in the expanded cell area will be further from the base station of the small cell than a UE located at the edge of original cell area and therefore its measured RSRP should be smaller. Similarly, a UE located in the original cell area of the small cell is supposed to be served by the small cell and thus RSRP of the small cell reported by this UE should generally be greater than RSRP of any neighboring cell reported by the same UE. However, if RSRP of the small cell reported by a UE is smaller than RSRP of one of the neighboring cells by a certain amount (e.g. the fourth threshold), this could indicate that the UE is located in the expanded cell area.

Turning back to FIG. 6, at block 602, in response to determining that the monitored DL interference is lower than the second threshold, the base station of the small cell can select one or more neighboring cells from its neighboring cells, between which and the small cell CRE is established. According to an example, if it is determined that RSRQ of the small cell in a non-ABS subframe is greater than a fifth threshold, then all neighboring cells between which and the small cell CRE is established can be selected. As described before, UEs served by the small cell may be configured to measure and report their individual RSRQ/RSRP values. Herein, RSRQ of a cell refers to an average value, a weighted average value or some kind of statistic value of the individual RSRQ values reported by different UEs served by this cell. Likewise, RSRP of a cell in this application document refers to an average value, a weighted average value or some kind of statistic value of the individual RSRP values reported by different UEs served by this cell. In another example, if CRE is established between a neighboring cell and the small cell and RSRP of this neighboring cell in any subframe is less than a sixth threshold, then this neighboring cell can be selected at block 602. Please be noted that the fifth and sixth thresholds can be predetermined by the operator. In an example, the fifth threshold can be a RSRQ value of the small cell at which the interference from neighboring cells is weaker than the signal strength of the small cell. And the sixth threshold can be a RSRP value of the small cell reported by UEs in the extended cell area plus a certain negative hysteresis value.

At block 603, the base station of the small cell can decrease the CRE configuration of the small cell associated with at least one of the selected neighboring cells.

In an example, decreasing the CRE configuration of the small cell associated with at least one of the selected neighboring cells may comprise disabling CRE between the small cell and the at least one of the selected neighboring cells; or reducing a size of an expanded cell area for the CRE between the small cell and the at least one of the selected neighboring cells, without disabling CRE. By decreasing CRE configuration in case of a low DL interference to the small cell, UEs in a decreased cell area of the extended cell area of the small cell can be served by the cell with the largest DL signal strength. Herein, the term “decreased cell area” refers to an area of the extended cell area that is reduced due to decreasing of CRE configuration and would be the same as the extended cell area, if CRE is disabled. In addition, by disabling CRE in case of a low DL interference to the small cell, spectrum efficiency in the neighboring cell (e.g. a macro cell) can be improved, because DL data transfer is also allowed in ABS subframes.

With reference to FIG. 8 now, FIG. 8 illustrates a flow diagram of a method for decreasing CRE configuration according to another embodiment of the present disclosure. As shown, blocks 801-803 in FIG. 8 are the same as blocks 601-603 and will not be described in detail herein. After decreasing CRE configuration of the small cell associated with at least one of the selected neighboring cells at block 803, a timer can be set at block 804, during a period of which increasing CRE configuration associated with the at least one of the selected neighboring cells is prevented.

Please be noted that increasing CRE configuration due to high UL interference and decreasing CRE configuration due to low DL interference may usually be executed separately by the base station of the small cell. For example, when a neighboring cell is selected to increase CRE configuration between this neighboring cell and the small cell, as described in e.g. block 302, it is possible that this neighboring cell is not the one that causes UL interference to the small cell. In this case, this neighboring cell would soon be detected as causing low DL interference to the small cell, as described in block 602, and hence CRE configuration between it and the small cell would be soon decreased. This may cause a frequent CRE adaptation, which can degrade performance of the communication network. By starting a timer after CRE configuration is decreased during the time period of which increasing CRE configuration between this neighboring cell and the small cell is prohibited, the frequent adjustment of CRE configuration can be avoided, resulting in a better and more robust network performance.

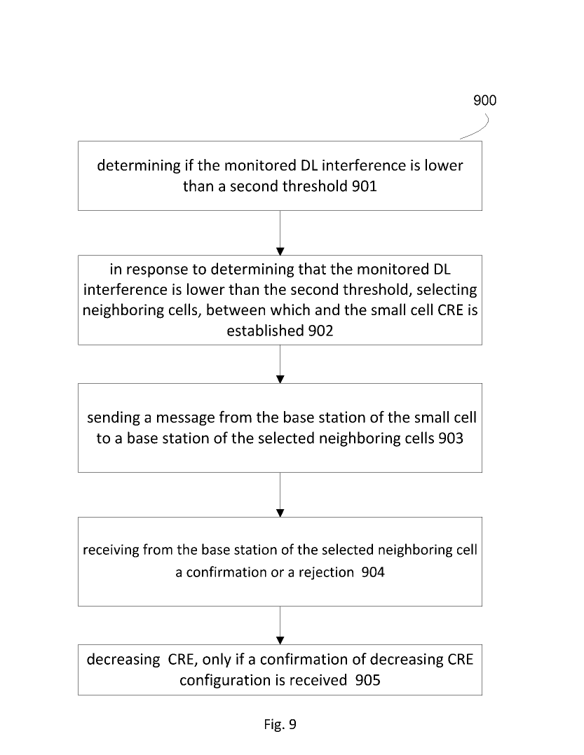

With reference to FIG. 9 now, FIG. 9 illustrates a flow diagram of a method for decreasing CRE configuration according to yet another embodiment. As shown, blocks 901 and 902 are the same as blocks 601 and 602 and will not be described in detail herein. After selecting at least one neighboring cell from the one or more neighboring cells of the small cell at block 902, the base station of the small cell may send a message to a base station of the at least one selected neighboring cell at block 903. The message may include a request for decreasing CRE configuration. Upon receiving the message, the base station of the at least one selected neighboring cell may determine whether to grant the request for decreasing CRE configuration or not and make a corresponding reply. At block 904, the base station of the small cell may receive from the base station of the at least one selected neighboring cell a confirmation or a rejection of decreasing CRE configuration. At block 905, the base station of the small cell may decrease CRE configuration between the small cell and the at least one selected neighboring cell only if a confirmation of decreasing CRE configuration is received.

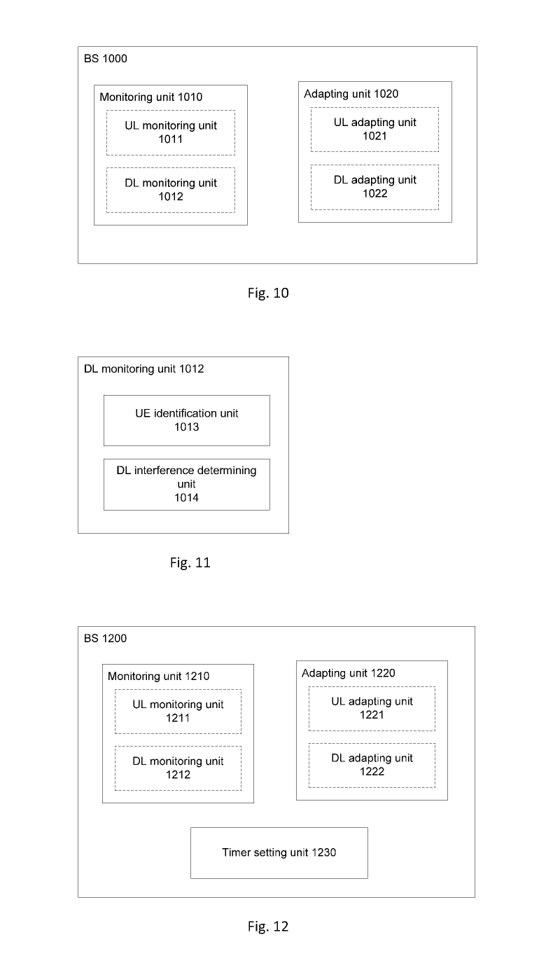

In the following, examples of a base station of a small cell will be described in detail. With reference to FIG. 10 now, FIG. 10 illustrates a diagrammatic view of a base station 1000 of a small cell according to an embodiment of the present disclosure. The small cell has a service area that is within or adjacent to service area(s) of one or more neighboring cells. As shown, the base station 1000 comprises a monitoring unit 1010 and an adapting unit 1020. The monitoring unit 1010 is configured to monitor uplink (UL) or downlink (DL) interference to the small cell due to the neighboring cells; and the adapting unit 1020 is configured to adapt cell range expansion (CRE) configuration of the small cell associated with at least one of the neighboring cells based on the monitored interference. As explained above, by adapting CRE configuration between the small cell and its neighboring cells based on UL/DL interference to the small cell, the work load for an operator's manual deployment and maintenance of the small cell and its CRE configuration can be relieved. In addition, by adapting CRE configuration based on UL/DL interference to the small cell, the CRE configuration can be automatically optimized since all the factors that could affect CRE configuration are all taken into account in the resulting interference to the small cell. This can improve the efficiency of the heterogeneous network.

In an example, the monitoring unit 1010 may comprise a UL monitoring unit 1011 which may be configured to monitor the UL interference to the small cell based on at least one of signal-to-interference-plus-noise ratio (SINR) values and interference-over-thermal (IoT) values of one or more UL signals received by the base station 1000 of the small cell. The adapting unit 1020 may comprise a UL adapting unit 1021, which may be configured to determine whether the monitored UL interference is higher than a first threshold or not; in response to determining that the monitored UL interference is higher than the first threshold, select a neighboring cell from the one or more neighboring cells; and increase the CRE configuration of the small cell associated with the selected neighboring cell. In an example, the UL adapting unit 1021 may be configured to select the neighboring cell from a neighboring cell list maintained by the base station of the small cell, based on an automatic neighbor relation (ANR) function, or by recognizing a cell identification from a demodulation reference signal or random access preamble received by the base station of the small cell.

In an example, the UL adapting unit 1021 may be configured to increase the CRE configuration of the small cell associated with the selected neighboring cell by enabling CRE between the small cell and the selected neighboring cell if CRE is not enabled between the small cell and the selected neighboring cell; or enlarging a size of an expanded cell area for the CRE between the small cell and the selected neighboring cell if CRE is already enabled between the small cell and the selected neighboring cell.

In an example, the monitoring unit 1010 may further comprise a DL monitoring unit 1012 which may be configured to monitor DL interference to the small cell and correspondingly, the adapting unit 1020 may further comprise a DL adapting unit 1022 which may be configured to determine whether the monitored DL interference is lower than a second threshold or not; in response to determining that the monitored DL interference is lower than the second threshold, select one or more neighboring cells from the neighboring cells, between which and the small cell CRE is established; and decrease the CRE configuration of the small cell associated with at least one of the selected neighboring cells. The DL monitoring unit 1012 may select all neighboring cells between which and the small cell CRE is established, if RSRQ of the small cell in a non-ABS subframe is greater than a fifth threshold. Alternatively, if CRE exists between a neighboring cell and the small cell and RSRP of this neighboring cell in any subframe is less than a sixth threshold, this neighboring cell can be selected by the DL monitoring unit 1012. Examples of the fifth and sixth thresholds have been given before and will not be described herein. According to an example, the DL adapting unit 1022 may be configured to decrease the CRE configuration of the small cell associated with at least one of the selected neighboring cells by disabling CRE between the small cell and the at least one of the selected neighboring cells; or reducing a size of an expanded cell area for the CRE between the small cell and the at least one of the selected neighboring cells, without disabling CRE.

In an example, the base station 1000 may further include a transceiver (not shown in FIG. 10). After a neighboring cell is selected by the UL adapting unit 1021, the transceiver may be configured to send a message from the base station of the small cell to a base station of the selected neighboring cell. The message can include a cell type of the small cell and a request for increasing CRE configuration. The transceiver may be further configured to receive from the base station of the selected neighboring cell a confirmation or a rejection of increasing CRE configuration. The UL adapting unit 1021 may be further configured to increase CRE configuration between the small cell and the selected neighboring cell, only if a confirmation of increasing CRE configuration is received by the transceiver. The cell type may be a cell size and the transceiver may be configured to receive a confirmation of enabling CRE only if a size of the small cell is not larger than a size of the selected neighboring cell in case no CRE exists between the small cell and the selected neighboring cell.

In another example where DL interference is monitored by the DL monitoring unit 1012, after one or more neighboring cells are selected by the DL adapting unit 1022, the transceiver may further be configured to send a message from the base station of the small cell to a base station of the at least one of the selected neighboring cells. The message can include a request for decreasing CRE configuration. The transceiver may further be configured to receive from the base station of the at least one of the selected neighboring cells a confirmation or a rejection of decreasing CRE configuration. In this example, the DL adapting unit 1022 may be further configured to decrease CRE configuration between the small cell and the at least one of the selected neighboring cells, only if a confirmation of decreasing CRE configuration is received by the transceiver.

An example of the DL monitoring unit 1012 is shown in FIG. 11. As shown, the DL monitoring unit 1012 may comprise a UE identification unit 1013 and a DL interference determining unit 1014. The UE identification unit 1013 may be configured to identify one or more user equipments (UEs) in an expanded cell area of the small cell which is generated by CRE. The DL interference determining unit 1014 may be configured to determine DL interference to the small cell based on signal quality measurements reported by the identified UEs. In an example, the UE identification unit 1013 may be configured to identify one or more user equipments (UEs) in an expanded cell area by configuring one or more UEs served by the small cell to measure and report reference signal received powers (RSRP) of the small cell and the neighboring cells; and identifying a UE as being in the expanded cell area, if RSRP of the small cell reported by the UE is smaller than a third threshold, or if RSRP of the small cell reported by the UE is smaller than RSRP of one of the neighboring cells by a fourth threshold. The third and fourth thresholds can be predetermined by the operator. An example of the third threshold has been given above.

With reference to FIG. 12 now, FIG. 12 illustrates a diagrammatic view of a base station 1200 of a small cell according to another embodiment. The base station 1200 is almost the same as the base station 1000 shown in FIG. 10, except that the base station 1200 may further comprise a timer setting unit 1230. Detailed description of the monitoring unit 1210, the adapting unit 1220 and the sub-units included therein (i.e. UL monitoring unit 1211, DL monitoring unit 1212, UL adapting unit 1221 and DL adapting unit 1222) will be omitted here and can be referred to description of FIG. 10. The timer setting unit 1230 may be configured to, upon CRE configuration of the small cell associated with the at least one of the selected neighboring cells being decreased by the DL adapting unit 1222, set a timer, during a period of which increasing CRE configuration associated with the at least one of the selected neighboring cells is prevented. By starting a timer after CRE configuration is decreased during the time period of which increasing CRE configuration between this neighboring cell and the small cell is prohibited, frequent adjustment of CRE configuration can be avoided, as explained above.

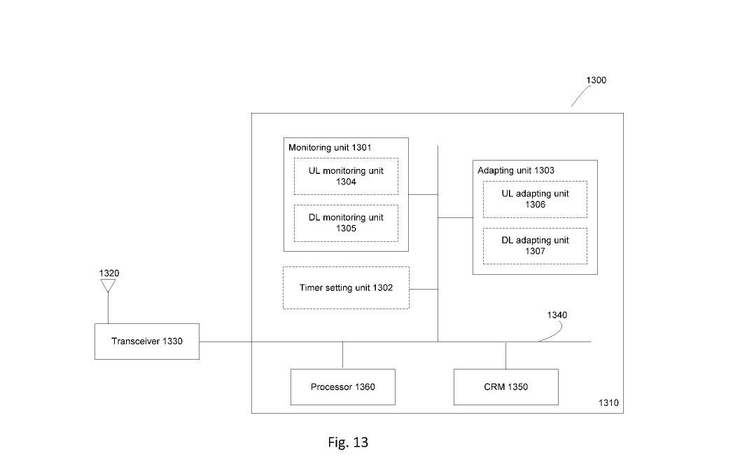

FIG. 13 illustrates examples of a hardware implementation for a base station 1300 of a small cell according to an embodiment. The base station 1300 employs a processing system 1310, may be implemented with a bus architecture, represented generally by the bus 1340. The bus 1340 may include any number of interconnecting buses and bridges depending on the specific application of the processing system 1310 and the overall design constraints. The bus 1340 links together various circuits including one or more processors and/or hardware modules, represented by the processor 1360 and the computer-readable medium 1350. The bus 1340 may also link various other circuits such as timing sources, peripherals, voltage regulators, and power management circuits, which are well known in the art, and therefore, will not be described any further.

The base station 1300 includes a processing system 1310 coupled to a transceiver 1330. The transceiver 1330 is coupled to one or more antennas 1320. The transceiver 1330 enables communicating with various other apparatus over a transmission medium. The processing system 1310 includes a processor 1360 coupled to a computer-readable medium 1350. The processor 1360 is responsible for general processing, including the execution of software stored on the computer-readable medium 1350. The software, when executed by the processor 1360, causes the processing system 1310 to perform the various functions described for any particular base station. The computer-readable medium 1350 may also be used for storing data that is manipulated by the processor 1360 when executing software.

The processing system 1310 may contain units 1301-1303 linked together by the bus 1340. In an example, the processing system 1310 includes a monitoring unit 1301 and an adapting unit 1302. The monitoring unit 1301 is utilized to monitor uplink (UL) or downlink (DL) interference to the small cell due to one or more neighboring cells of the small cell. The adapting unit 1302 is used to adapt cell range expansion (CRE) configuration of the small cell associated with at least one of the neighboring cells based on the monitored interference.

In particular, the monitoring unit 1301 may comprise a UL monitoring unit 1304 and a DL monitoring unit 1305 and the adapting unit 1303 may comprise a UL adapting unit 1306 and a DL adapting unit 1307. The UL monitoring unit 1304 can be used to monitor UL interference to the small cell, and the UL adapting unit 1306 can be used to determine whether the monitored UL interference is higher than a first threshold or not; in response to determining that the monitored UL interference is higher than the first threshold, select a neighboring cell from the one or more neighboring cells; and increase the CRE configuration of the small cell associated with the selected neighboring cell. The DL monitoring unit 1305 can be used to monitor DL interference to the small cell and the DL adapting unit 1307 can be used to determine whether the monitored DL interference is lower than a second threshold or not; in response to determining that the monitored DL interference is lower than the second threshold, select one or more neighboring cells from the neighboring cells, between which and the small cell CRE is established; and decrease the CRE configuration of the small cell associated with at least one of the selected neighboring cells.

In another example, the processing system 1310 may include a timer setting unit 1302 which can be used to, upon the CRE configuration of the small cell associated with the at least one of the selected neighboring cells being decreased by the DL adapting unit, set a timer, during a period of which increasing CRE configuration associated with the at least one of the selected neighboring cells is prevented.

Those of skill would further appreciate that the various illustrative logical blocks, units, modules, circuits, and algorithm steps described in connection with the disclosure herein may be implemented as electronic hardware, computer software, or combinations of both. To clearly illustrate this interchangeability of hardware and software, various illustrative components, blocks, units, modules, circuits, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as causing a departure from the scope of the present disclosure.

The various illustrative logical blocks, units, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a base station. In the alternative, the processor and the storage medium may reside as discrete components in a base station.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method performed by a base station of a small cell which has a service area that is within or adjacent to service area(s) of one or more neighboring cells, the method comprising,
monitoring uplink (UL) or downlink (DL) interference to the small cell due to the neighboring cells; and
based on the monitored interference, adapting cell range expansion (CRE) configuration of the small cell associated with at least one of the neighboring cells.

2. The method of claim 1, wherein the UL interference to the small cell is monitored based on at least one of signal-to-interference-plus-noise ratio (SINR) values and interference-over-thermal (IoT) values of one or more UL signals received by the base station of the small cell.

3. The method of claim 1, wherein the UL interference to the small cell is monitored and the adapting CRE configuration of the small cell comprises:
determining whether the monitored UL interference is higher than a first threshold or not;
in response to determining that the monitored UL interference is higher than a first threshold, selecting a neighboring cell from the one or more neighboring cells; and
increasing the CRE configuration of the small cell associated with the selected neighboring cell.

4. The method of claim 3, wherein the increasing the CRE configuration of the small cell associated with the selected neighboring cell comprises,
if CRE is not enabled between the small cell and the selected neighboring cell, enabling CRE between the small cell and the selected neighboring cell; or
if CRE is already enabled between the small cell and the selected neighboring cell, enlarging a size of an expanded cell area for the CRE between the small cell and the selected neighboring cell.

5. The method of claim 3, wherein the neighboring cell is selected from a neighboring cell list maintained by the base station of the small cell, is selected based on an automatic neighbor relation (ANR) function, or is selected by recognizing a cell identification from a demodulation reference signal or random access preamble received by the base station of the small cell.

6. The method of claim 3, wherein before said increasing, the method further comprises,
sending a message from the base station of the small cell to a base station of the selected neighboring cell, including a cell type of the small cell and a request for increasing CRE configuration; and
receiving from the base station of the selected neighboring cell a confirmation or a rejection of increasing CRE configuration;
wherein CRE configuration between the small cell and the selected neighboring cell is increased, only if a confirmation of increasing CRE configuration is received by the base station of the small cell.

7. The method of claim 6, wherein the cell type is a cell size and in case no CRE exists between the small cell and the selected neighboring cell, a confirmation of enabling CRE is received by the base station of the small cell only if a size of the small cell is not larger than a size of the selected neighboring cell.

8. The method of claim 3, further comprising repeating said selecting and increasing until the monitored UL interference is lower than the first threshold or all the neighboring cells are selected.

9. The method of claim 1, wherein the DL interference to the small cell is monitored and the adapting CRE configuration of the small cell comprises:
determining whether the monitored DL interference is lower than a second threshold or not;
in response to determining that the monitored DL interference is lower than the second threshold, selecting one or more neighboring cells from the neighboring cells, between which and the small cell CRE is established; and
decreasing the CRE configuration of the small cell associated with at least one of the selected neighboring cells.

10. The method of claim 9, wherein decreasing the CRE configuration of the small cell associated with at least one of the selected neighboring cells comprises:
disabling CRE between the small cell and the at least one of the selected neighboring cells; or reducing a size of an expanded cell area for the CRE between the small cell and the at least one of the selected neighboring cells, without disabling CRE.

11. The method of claim 1, wherein monitoring DL interference to the small cell comprises, identifying one or more user equipments (UEs) in an expanded cell area of the small cell which is generated by CRE; and
determining DL interference to the small cell based on signal quality measurements reported by the identified UEs.

12. The method of claim 11, wherein said identifying one or more user equipments (UEs) in an expanded cell area comprises:
configuring one or more UEs served by the small cell to measure and report reference signal received powers (RSRP) of the small cell and the neighboring cells; and
identifying an UE as being in the expanded cell area, if RSRP of the small cell reported by the UE is smaller than a third threshold, or if RSRP of the small cell reported by the UE is smaller than RSRP of one of the neighboring cells by a fourth threshold.

13. The method of claim 11, wherein the signal quality measurements reported by the identified UEs include reference signal received qualities (RSRQ) of the small cell in a non-almost-blank-subframe (non-ABS subframe) and reference signal received powers (RSRP) of the neighboring cells in any subframe.

14. The method of claim 9, further comprising:
upon decreasing the CRE configuration of the small cell associated with the at least one of the selected neighboring cells, setting a timer, during a period of which increasing CRE configuration associated with the at least one of the selected neighboring cells is prevented.

15. The method of claim 13, wherein said selecting comprises:
selecting all neighboring cells between which and the small cell CRE is established, if RSRQ of the small cell in a non-ABS subframe is greater than a fifth threshold; or
selecting a neighboring cell between which and the small cell CRE is established and the RSRP of which in any subframe is less than a sixth threshold.

16. The method of claim 9, wherein before said decreasing, the method further comprises,
sending a message from the base station of the small cell to a base station of the at least one of the selected neighboring cells, including a request for decreasing CRE configuration; and
receiving from the base station of the at least one of the selected neighboring cells a confirmation or a rejection of decreasing CRE configuration;
wherein CRE configuration between the small cell and the at least one of the selected neighboring cells is decreased, only if a confirmation of decreasing CRE configuration is received by the base station of the small cell.

17. A base station of a small cell which has a service area that is within or adjacent to service area(s) of one or more neighboring cells, the base station comprising,
a monitoring unit configured to monitor uplink (UL) or downlink (DL) interference to the small cell due to the neighboring cells; and
an adapting unit, configured to adapt cell range expansion (CRE) configuration of the small cell associated with at least one of the neighboring cells based on the monitored interference.

18. The base station of claim 17, wherein the monitoring unit comprises a UL monitoring unit which is configured to monitor
the UL interference to the small cell based on at least one of signal-to-interference-plus-noise ratio (SINR) values and interference-over-thermal (IoT) values of one or more UL signals received by the base station of the small cell.

19. The base station of claim 17, wherein the monitoring unit is configured to monitor UL interference to the small cell, and the adapting unit comprises a UL adapting unit configured to,
determine whether the monitored UL interference is higher than a first threshold or not;
in response to determining that the monitored UL interference is higher than a first threshold, select a neighboring cell from the one or more neighboring cells; and
increase the CRE configuration of the small cell associated with the selected neighboring cell.

20. The method of claim 17, wherein the monitoring unit is configured to monitor DL interference to the small cell and the adapting unit comprises a DL adapting unit which is configured to,
determine whether the monitored DL interference is lower than a second threshold or not;
in response to determining that the monitored DL interference is lower than the second threshold, select one or more neighboring cells from the neighboring cells, between which and the small cell CRE is established; and
decrease the CRE configuration of the small cell associated with at least one of the selected neighboring cells.

21. The base station of claim 17, wherein the monitoring unit comprises a DL monitoring unit which is configured to monitor DL interference to the small cell, and wherein the DL monitoring unit comprises a UE identification unit configured to
identify one or more user equipments (UEs) in an expanded cell area of the small cell which is generated by CRE; and a DL interference determining unit configured to
determine DL interference to the small cell based on signal quality measurements reported by the identified UEs.

22. The base station of claim 22, wherein said UE identification unit is configured to identify one or more user equipments (UEs) in an expanded cell area by:
configuring one or more UEs served by the small cell to measure and report reference signal received powers (RSRP) of the small cell and the neighboring cells; and
identifying a UE as being in the expanded cell area, if RSRP of the small cell reported by the UE is smaller than a third threshold, or if RSRP of the small cell reported by the UE is smaller than RSRP of one of the neighboring cells by a fourth threshold.

23. The base station of claim 20, further comprising:
a timer setting unit configured to, upon the CRE configuration of the small cell associated with the at least one of the selected neighboring cells being decreased by the DL adapting unit, set a timer, during a period of which increasing CRE configuration associated with the at least one of the selected neighboring cells is prevented.
